(19) United States
(12) Patent Application Publication
(10) Pub. No.: US 2002/0160825 A1
(43) Pub. Date: Oct. 31, 2002

(54) Amusement game having a probability-based award system

(76) Inventors: Neil D. Nicastro, Lake Forest, IL (US); Edward J. Suchocki, Buffalo Grove, IL (US); Shridhar P. Joshi, Skokie, IL (US)

Correspondence Address: JENKENS & GILCHRIST, P.C., 225 WEST WASHINGTON, SUITE 2600, CHICAGO, IL, 60606, US

(21) Appl. No.: 09/842,512

(22) Filed: Apr. 26, 2001

(51) Int. Cl. A63F 13/00

(52) U.S. Cl. 463/16

(57) ABSTRACT

A game device allows a player to play chance-based games and skill-based games. A skill-based game is provided as an initial game, with a chance-based game being provided subsequent to the skill-based game. The chance-based game gives the player a chance to win prizes, and whether a prize is won and the value of prizes are determined by the outcome of the chance-based game.

### FIELD OF THE INVENTION

The present invention relates generally to amusement devices and more specifically to an amusement device having a chance-based award system.

### BACKGROUND OF THE INVENTION

Traditionally, amusement games such as arcade games, console games, and computer games have presented players with a series of tasks to accomplish, generally through skillful manipulation of controls. In contrast, in a chance-based gaming environment such as a casino, a player generally wins or loses a game based on chance, sometimes with little to no skill being involved.

Both game styles have become extremely popular. However, the fundamental difference in style of gameplay has created two separate markets with only slight overlap. Players of chance-based games play because a small wager can end up as a large payout, and players of skill-based games prefer the challenge of more complex, skill-based games.

There is a constant desire among game designers, arcade owners, casino operators, and others involved in the amusement and gaming businesses to expand markets for all game types, but the difference in game types has led to two separate kinds of players. Casino games, for example, are generally fairly straightforward, requiring only the push of a single button or the play of a familiar game such as cards or bingo. Skill-based games, on the other hand, can be fairly complex, requiring strategic gameplay, quick reactions, good recall and/or visualization skills. Because of this difference, many casino players may be daunted by more complex amusement games. It is believed that the introduction to an amusement game through an interface such as a traditional casino game will provide casino gamers the chance to get accustomed to more detailed amusement games. At the same time, an amusement game player would see the benefits of a chance-based game if the awards of a chance-based game were applied to an amusement game. It is further believed that the combination of a probability-based award system and a traditional skill-based amusement game would lead to a beneficial combination of the two separate markets that have developed. Consequently, there exists a need for a style of game combining the probability-based gameplay of casino games with the more in-depth gameplay of skill-based amusement games.

### SUMMARY OF THE INVENTION

A system for operating an amusement game provides an initial skill-based video game, with success in the skill-based video game leading to an attempt at a chance-based game allowing the player to win prizes based on the outcome of the chance-based game.

The chance-based games may be based on known casino games, such as slot machines, keno games, poker and other card games, bingo games, and the like. The skill-based games may be selected from the wide variety of amusement game genres available, such as puzzle, logic, driving, trivia, fighting, action/adventure, role-playing, and sports games.

In another embodiment of the present invention, a first player may challenge a second player and win or lose credits based on the outcome of the challenge. This embodiment may be expanded to allow for challenges among multiple players at multiple locations.

In still another embodiment of the present invention, a player may gain access to new skill-based games or more difficult levels of skill-based games based upon the player's performance in the chance-based game. Further, a player may be able to win prizes or money based on his or her performance in a chance-based game.

According to another embodiment of the present invention, a player is provided with a game choice between one or more chance-based games and one or more skill-based games, with credits won in either game style being applicable to other games.

According to still another embodiment of the present invention, a scratch-ticket game is provided as a chance-based game, the scratch-ticket game awarding cash or merchandise prizes and further being adaptable for awarding progressive prizes.

The above summary of the presented invention is not intended to represent each embodiment, or every aspect of the present invention. This is the purpose of the figures and detailed description which follow.

### BRIEF DESCRIPTION OF THE DRAWINGS

The foregoing and other advantages of the invention will become apparent upon reading the following detailed description and upon reference to the drawings in which:

FIG. 1 is a perspective view of a game device according to one embodiment of the present invention;

FIG. 2 is a block diagram of game circuitry according to one embodiment of the present invention;

FIG. 3 is a flow diagram of game operation according to one embodiment of the present invention;

FIG. 4 is a flow diagram of game operation according to another embodiment of the present invention;

FIG. 5 is a flow diagram of game operation according to still another embodiment of the present invention;

FIG. 6 is a diagram showing a game device playing a scratch game according to one embodiment of the present invention; and

FIG. 7 is a block diagram showing the connection of multiple game devices according to one embodiment of the present invention.

While the invention is susceptible to various modifications and alternative forms, specific embodiments have been shown by way of example in the drawings and will be described in detail herein. However, it should be understood that the invention is not intended to be limited to the particular forms disclosed. Rather, the intent is to cover all modifications, equivalents, and alternatives falling within the spirit and scope of the invention as defined by the appended claims.

### DETAILED DESCRIPTION OF THE INVENTION

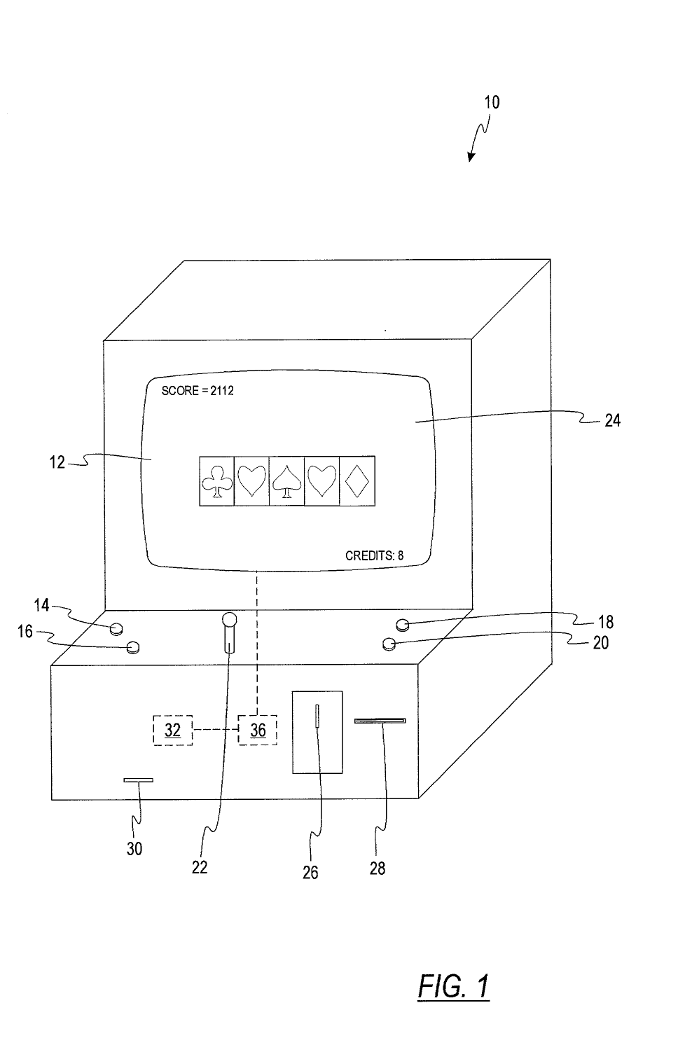

FIG. 1 shows a game device 10 adapted to play both chance-based games and skill-based games. The game device 10 includes at least one display, which may be a video monitor such as a CRT, LCD, or plasma monitor. Alternatively, the display 12 may incorporate mechanical display elements such as reels or animated mechanical devices. Several input devices are provided to allow player and/or operator interaction with the game device 10. FIG. 1 shows input buttons 14, 16, 18, and 20 and a standard joystick 22. A touch screen interface 24 may also be provided to enable interaction with the game device 10. Other inputs which may be used with the present invention include a track ball, a spinning paddle-type input, a flight-simulator style joystick, a steering wheel, a light pen or light gun, or any other game input known in the casino and video game arts.

The game device 10 also may include an input receptacle 26 for accepting tokens, coins, or cash, and a card reader/writer 28 or similar device adapted to write and read electronic and/or magnetic data to and from user cards such as magnetic cards, smart cards, or other storage media. Alternatively, a player may be identified through a PIN number input through the touch screen interface 24 or other input devices. The use of a PIN number may allow the game device 10 to recognize a player and to access a central database of player information, including information regarding credits and time currently available to the player. A ticket output slot 30 may also be provided to enable the game device 10 to award tickets or coupons to successful players of the game device 10.

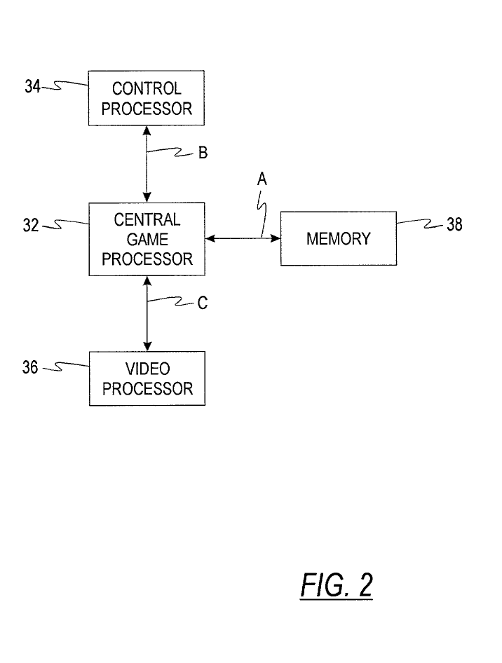

Turning now to FIG. 2, a block diagram of game circuitry according to one embodiment of the present invention is shown. The general operation of the game device 10 according to the present invention is coordinated by a central game processor 32, and specific game operations may be controlled by other processors such as a control processor 34 and a video processor 36. In one embodiment, all game operations are coordinated by the central game processor 32, eliminating the need for other processors. In addition, memory 38 is provided. The memory 38 may be a combination of memory devices such as RAM and ROM devices, and may consist of multiple memory devices such as EPROMS, optical storage, hard drives, and other storage media.

The arrows in FIG. 2 show data flows to enable the operation of the game device 10. Arrow “A” shows data flow between the central game processor 32 and the memory 38. This data flow allows information such as games, images, and sounds stored in the memory 38 to be accessed by the central game processor 32. Information on player status, such as credit information and frequency of play, may also be stored in the memory 38 and used by the central game processor 32 to enable or enhance the game experience. Arrow “B” shows data flow between the control processor 34 and the central game processor 32. This data flow allows control information, such as player inputs, to be received by the central game processor 32. The control data flow may also allow the central game processor 32 to notify the control processor 34 when the central game processor 32 is prepared to accept control-related input. Arrow “C” shows data flow between the central game processor 32 and the video processor 36. This video data flow may include information on updated or changing images as games are played on the game device 10.

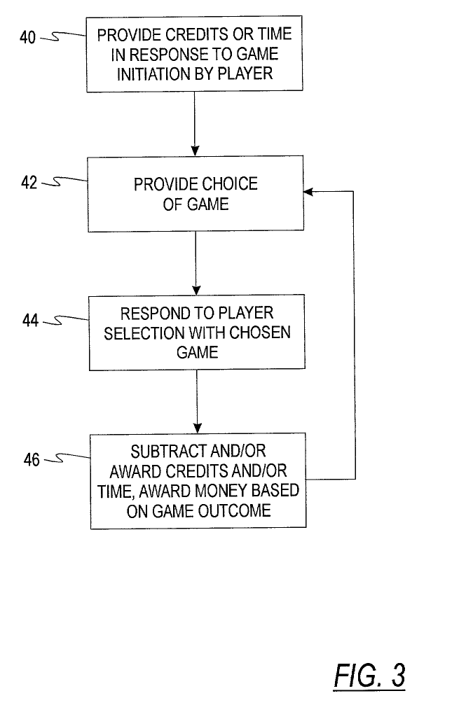

The processors and memory devices of the game device 10 according to the present invention serve to provide a variety of chance-based games and skill-based games to a player. Turning now to FIG. 3, a flow diagram of a basic game progression according to one embodiment of the present invention is shown. In the embodiment shown in FIG. 3, a player initiates a game and the game device 10 provides credits or time to the player in response to money input from a player, or in recognition of a player's card input into the card reader/writer 28.

Smart cards or magnetic cards may be used to track the credits available to a player from game to game, and the player may leave a gaming session and retain his number of credits through the use of a smart card. The player's information, such as his number of remaining credits and/or time may be stored on the smart card or at a central server or database, as described more fully below. When playing time, rather than credits, is used, the player is given a certain amount of time to continue playing games, so that a set amount of playing time will be available whether the player succeeds or fails at the games he is playing. Players may be given a choice as to whether they wish to use credits or time in their gameplay, and both credits and time may be recorded on a player's card. Following the provision of credits at block 40, the game device 10 of the embodiment shown in FIG. 3 allows a game choice as shown at block 42. The player may choose a particular game that appeals to him, or the player may be presented with two different menus, one containing skill-based games and the other containing chance-based games. Alternatively, the player may be presented with only a choice between skill-based games and chance-based games in general, with the game device 10 deciding which particular game to present to the player.

A skill-based game for use in the present invention includes any skill-based game of the type commonly seen at video arcades or played on home gaming consoles, such as racing, fighting, puzzle, adventure, trivia, role playing, sports, logic and strategy games. In general, such a game primarily relies on the skill of a player to determine the game's outcome, though some chance may come into the game. According to some embodiments of the present invention, skill-based games rely only on the skill of the player, with no elements of chance affecting the game outcome.

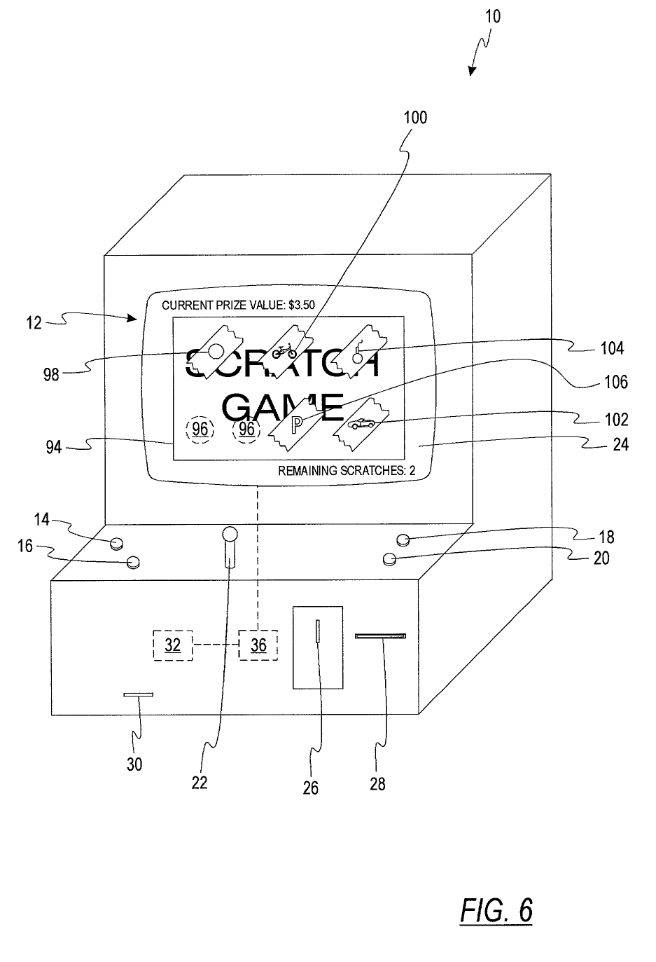

A chance-based game for use in the present invention includes any chance-based game of the type commonly seen at casinos, such as bingo, keno, slots, roulette, wheel of fortune, and dice games. Alternatively, the chance-based game may be a scratch-off type game of the style described below in reference to FIG. 6. The outcome of a chance-based game for use with the present invention may be dependent solely upon chance.

Next, as shown at block 44, the game responds to the player's choice of game by allowing the player to play the chosen game. After the game has been played, the game device 10 may subtract and/or award credits and/or time based on the outcome of the game, as shown at block 46. The game device 10 may also award a cash prized based on the game outcome at this point.

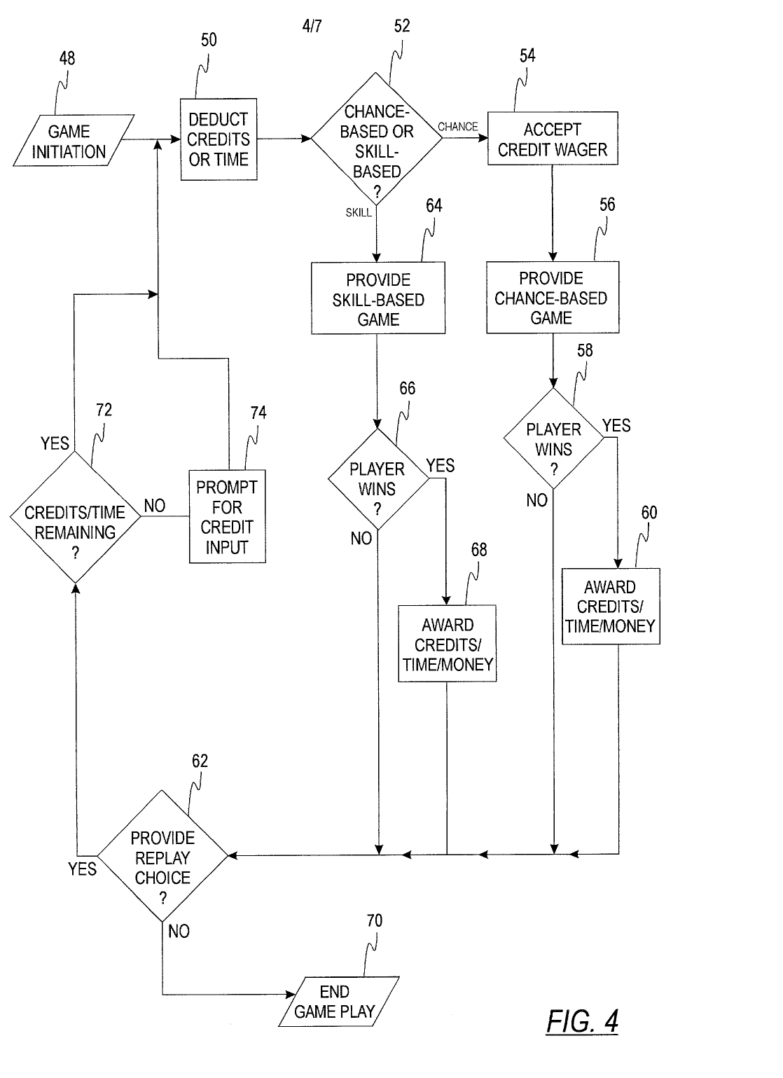

Turning now to FIG. 4, a flow diagram showing an alternative game process according to the present invention is shown. The game is initiated at block 48, for example by a player inputting credits or a card having credits or time on it, or by a player inputting a pin number or other personal information identifying himself to the game device 10. Next, as shown at block 50, the game device 10 deducts credits or time to allow the player to choose a game. All games may have the same cost in credits, or games may be provided at several cost levels, with the more desirable, popular, or exciting games costing more credits. At block 50, the player may also be provided with a choice to convert credits into time or time into credits, according to an exchange value. Next, at decision block 52, the game device 10 allows the player to choose a chance-based or a skill-based game.

Some chance-based games provide the opportunity for greater payouts if higher wagers are chosen at the beginning of the game. If a chance-based game accepting multiple wager levels is chosen, the game device 10 accepts a credit “wager” as shown at block 54. Next, the chance-based game is provided as shown at block 56. While the game is provided, the player is presented with choices and the game device 10 accepts player input corresponding to the choices. Next, at decision block 58, the game device 10 determines whether the player has been successful in the chance-based game. If the player has won in the chance-based game, the game device 10 awards credits, time, and or a cash prize to the player as shown at block 60. If the player has not won, the game device logic proceeds to block 62 to provide the player with a choice to play another game.

Returning to block 52, if the player decides to play a skill-based game, the game logic proceeds to block 64, where the game device 10 provides a skill-based game to the player. Skill-based games may be provided solely for entertainment value without allowing a player to win any credits or time by playing skill-based games. If skill-based games are presented only for entertainment value, the game logic proceeds directly to decision block 62 after providing the skill-based game at block 64. Alternatively, a player may be awarded credits, time, and/or a cash prize in response to a good performance in the skill-based game at block 64. If skill-based games are adapted to reward credits, time, and/or a cash prize, the game device 10 determines at decision block 66 whether the player's performance in the skill-based game is sufficient to earn the player an award. If the player's performance is sufficient to garner an award, the game device 10 proceeds to award the player as shown at block 68 before proceeding to the replay decision at block 62. If the player's performance is not sufficient to win credits, time, and/or a cash prize at block 66, the game device 10 proceeds to provide the player with a replay choice as shown at block 62.

If the player decides not to continue playing at block 62, the game ends as shown at block 70. At this point, if the player uses a card to track his available time and/or credits, the player may remove the card to use it during another playing session. If the player decides to play another game at block 62, the game device 10 proceeds to determine if the player has any credits and/or time remaining, at decision block 72. If the player has credits and/or time remaining, the game device 10 proceeds to deduct credits or time as shown at block 50 before proceeding with the gameplay. If the player does not have any credits or time remaining, the player is prompted for credit inputs as shown at block 74, and if credits are entered, they are deducted at block 50 before gameplay proceeds.

The interaction of chance-based games and skill-based games according to the present invention allows a number of variations to be used with credits, time, and gameplay. For example, more than one player may be able to compete on one game device 10. In this multiple player embodiment, the players may be given the option of pooling a certain number of their credits, with the winner of a chance-based game or a skill-based game earning the pooled credits. To enable multiplayer gaming, the game device 10 may be provided with several card reader/writers 28, or it may take card readings in series from the players involved. If several game devices 10 are connected in a network, a player in a multiplayer game on a single game device 10 whose card has been read in series could be barred from using the card to play other connected game devices, so that only one uniform record of the player's credits, time, and any other information is in existence at any one time.

The game device 10 according to the present invention enables a player to play a chance-based game with which the player may be familiar in order to earn credits and/or time to play skill-based games which are newer or less familiar. The principles of the present invention may be applied to table top amusement games, such as those found in taverns and restaurants, upright arcade cabinet games, or Internet games. Further, the ticket output slot 30 may enable the printing of tickets or coupons directed to valuable prizes based on the accumulation of credits or time by a player. In this way, the game device 10 according to the present invention creates the opportunity for a player to choose his favorite way of playing, whether it is to amass credits and time to play more games, or to exchange credits or time for prizes or money. According to one embodiment of the present invention, a player may pay a flat monthly fee to play games as often as he wants. This arrangement allows the player to minimize losses and learn new games with little cost.

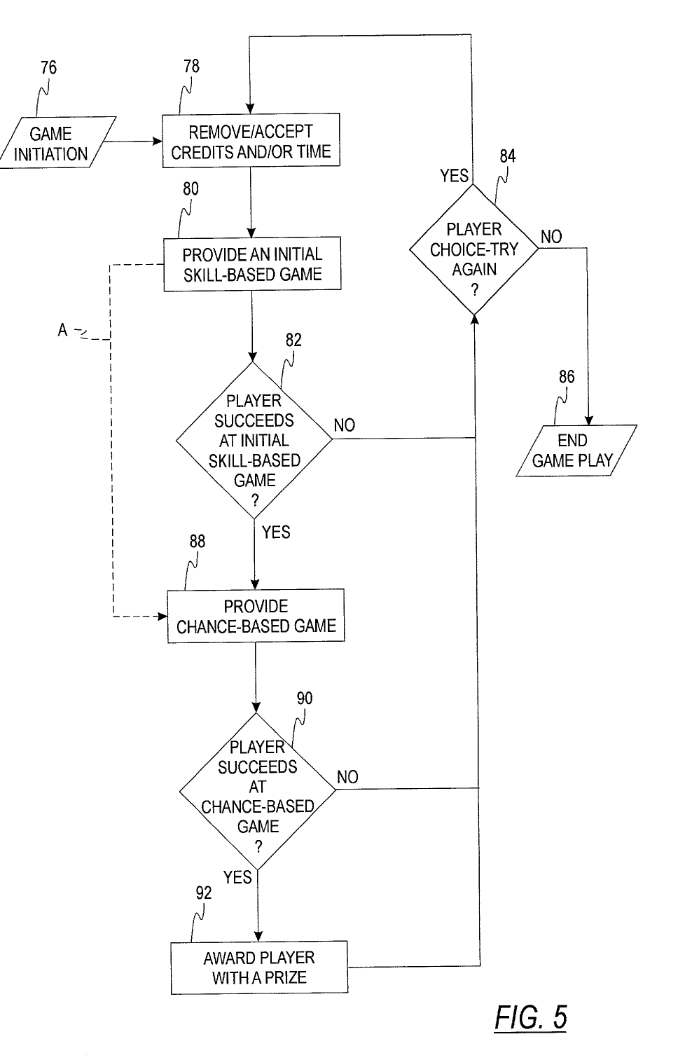

Turning now to FIG. 5, a flow diagram of game logic for a game device 10 according to the present invention which initially presents a player with a skill-based game is shown. As shown at block 76, a game is initiated by a player, for example by the player inserting money or tokens into the input receptacle 26 of the game device 10 or by a player inserting a magnetic card or smart card into the card reader/writer 28. At this point, the game device 10 records a number of credits or an amount of play time available for the current playing session. Next, the game device 10 removes or accepts credits and/or time from the player's number of credits or amount of play time available for the current playing session, as shown at block 78. This removal or acceptance of credits and/or time enables the play of a initial skill-based game as shown at block 80. Alternatively, the game device 10 may be adapted to provide an initial skill based game as shown at block 80 without requiring credits and/or time to be deducted from a player.

The initial skill-based game used at block 80 may be selected from a variety of skill-based games, ranging from very simple games involving only one step to more complex games requiring multiple steps or the manipulation of multiple input buttons, the touch screen interface 24, and/or the standard joystick 22. The initial skill-based game may be a test of timing and reflexes, requiring the player to press an input button or operate some other input control when several events are happening simultaneously. For example, three clock-like dials may be presented with hands rotating around axes, with the player succeeding at the skill-based game by providing input when the hands fall within indicated arcs on the dials. As another example, a single trivia question may be asked as an initial game, with a player correctly answering the question or coming closest to the answer in a numerical question succeeding at the initial game. Alternatively, the trivia question may be an initial game, with the player proceeding to a chance-based game whether the player's answer is correct or not. The initial skill-based game may be a very quick-playing game which allows a fast determination of whether a player succeeds, thereby moving the player more quickly through the game logic.

The game device 10 next determines if the player is successful at the initial skill-based game, as shown at decision block 82. If the player is unsuccessful, the game proceeds to allow the player to choose whether or not to play again at block 84. If the player chooses to play again, credits are removed or accepted at block 78. If the player chooses not to play again, the gameplay is terminated as shown at block 86.

Returning to block 82, if the game device 10 determines that the player succeeds at the initial skill-based game, the player is provided with a chance-based game as shown at block 88. Alternatively, the player may be provided with a chance-based game regardless of the player's performance in the skill-based game, as shown by dotted arrow “A.” Next, as shown at block 90, the game device 10 determines whether the player succeeds at the chance-based game. If the player is unsuccessful, the game logic returns to decision block 84 to give the player another chance at playing. If the player is successful, a prize may be awarded as shown at block 92. The player's chances of winning at the chance-based game may be increased if the player's accomplishments in the skill-based game meet at least one criterion, such as the achievement of a predetermined score or reaching an advanced level.

Different types and levels of success may be available to the player during the chance-based game. For example, the player may be awarded with a prize if certain criteria are met in the chance-based game. Prizes awarded may include money, free games, free credits and/or time, merchandise such as bicycles or cars, services, food, and the like. Alternatively, the player may simply be rewarded with another attempt at the chance-based game or the skill-based game. The player may be presented with a first chance-based game which determines the type of prize that will be made available to the player and a second chance-based game is used to determine the prize level within that category. For example, the first chance-based game may determine that the player is eligible for a prize of merchandise, and the second chance-based game may determine that the player wins a jacket rather than a bicycle. Following the award of a prize, such as credits, time, merchandise, services, and/or cash at block 92, the game device 10 gives the player a chance to play again as shown at block 84. According to an alternative embodiment, the initial skill-based game at block 80 may be bypassed, with the game logic proceeding immediately to the chance-based game at block 88. The skill-based game may be considered the primary game, with the chance-based game being a secondary game, played after the primary game. The chance-based game may be implemented regardless of a player's performance in the skill-based game, and may be carried out independently of the skill-based game. Alternatively, the chance-based game may be the first and only game played during a game session, with no need to play a skill-based game as a primary game.

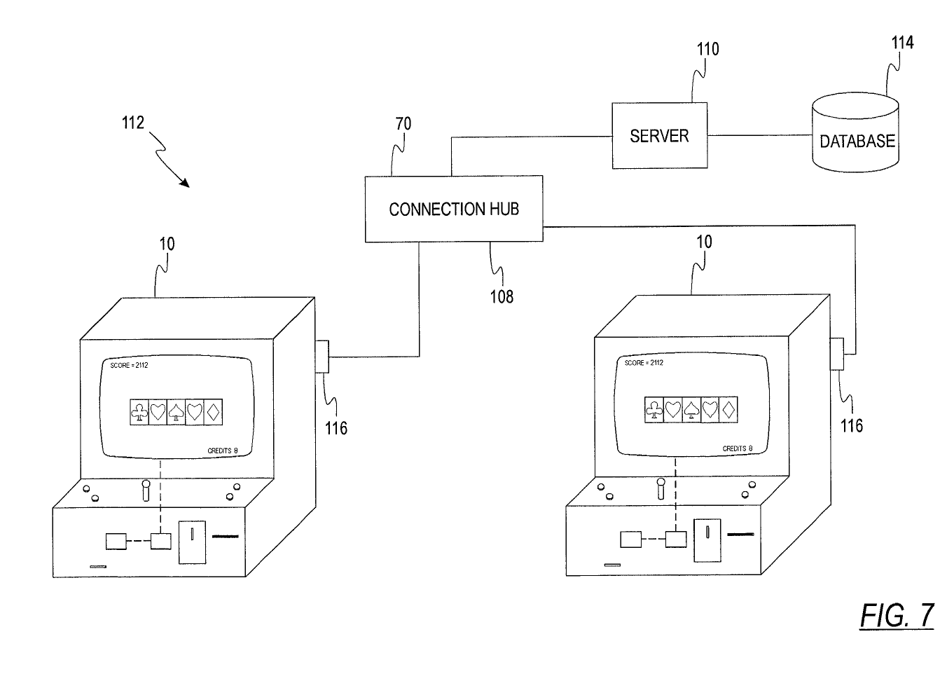

When prizes other than free time and/or credits, such as services, merchandise, or money, are awarded, the game device 10 carries out a process assuring that the player can be contacted and awarded the correct prize. To accomplish this, the player may register during gameplay, by entering information such as the player's name, address, phone number, social security number, and the like into the game device 10. This information may be linked to a PIN number which is given to the player, whether via the game device 110, via mail, electronically over the Internet, or using other communication means. The player's identification information may be stored at a central location when game devices 10 are connected to a network, as described more fully in reference to FIG. 7, below. Alternatively, once the game device 10 has determined that a player has met criteria for being awarded a prize, the game device 10 may notify the player that the player must call a phone number, which may be displayed on the display 12, in order to give identification and contact information to an operator or an electronic telephone input system.

Once this information has been stored by game coordinators and operators, a player may identify himself to game devices 10 in the future through the use of a pin number or an identification card, such as a magnetic card, a smart card, or other types of security devices, such as wands or cards which use optical or other electromagnetic recognition systems. When a player has identified himself to a game device 10, the game device 10 recognizes the player and links the playing session with identification information either stored locally on the game device 10 or stored remotely at a central information storage location, so that prizes and other information will be properly forwarded to the player. This information may be stored regardless of whether a prize is to be awarded, as a method of tracking player performance or preference over time, or as a method of tracking the amount of time and/or credits remaining for a player and informing the player of his remaining playing time and/or credits.

Turning now to FIG. 6, the game device 10 for operating a scratch-ticket game is shown. A scratch-ticket game according to the present invention uses the display 12 of the game device 10 to show a game ticket 94. The game ticket 94 is designed to resemble a scratchable game ticket as used in state lotteries and promotional games. An intact game ticket 94 has a number of scratchable areas 96. A player may “scratch” away the scratchable areas 96 to uncover symbols hidden beneath the scratchable areas 96 by interacting with the touch screen interface 24.

The symbols hidden beneath the scratchable areas 96 may take a variety of forms depending on the type of scratch-ticket game being played. FIG. 6 shows four different types of symbols for demonstration, though several other symbol types can be used in the present invention. A coin symbol 98 may be used to indicate a player's progression toward a cash prize. Coin symbols 98 may have denominations, with the player winning an amount of money equal to the sum of uncovered denominations. Merchandise symbols may also be used. For example, a bicycle symbol 100 may be used to show a player's progress toward winning a bicycle, and an automobile symbol 102 may be used to show a player's progress toward winning an automobile.

Another type of symbol that may be used is a junk symbol 104, which in FIG. 6 is represented as a bomb. A junk symbol 104 may be used to show that the player has not uncovered a valuable space, or to tally a number of worthless spaces a player has uncovered. According to one embodiment of a scratch-ticket game, when the player uncovers a predetermined number of junk symbols 104, that player's attempt at the chance-based game is terminated. More junk symbols may be placed beneath the scratchable areas 96 as a player progresses, so that the chance of finding a junk symbol with later scratches increases as compared to the chance of finding a junk symbol with an early scratch. Alternatively, no junk symbols are placed beneath a scratchable area 96 at the beginning of a scratch-ticket game, but junk symbols are added as the player activates more scratchable areas 96 to make the game more difficult as the player progresses. Junk symbols 104 may simply be worthless symbols which require the player to continue by choosing another scratchable area 96, or they may be game-terminating symbols, such as a bomb-shaped symbol as shown in FIG. 6, causing the play of the scratch-ticket game to end immediately.

In either a standalone embodiment or a networked embodiment of the game device 10 according to the present invention, a progressive symbol 106 may be used to indicate a player's progression toward a progressive prize goal. A progressive prize increases with the number of plays on a standalone game device 10 or the number of plays on any of several connected game devices 10, explained with more detail in connection with FIG. 7, below. A progressive prize may increase according to the amount of money or credits input into the game device 10, or it may increase by a pre-set amount every time the game device 10 is played. For example, a progressive prize may increase by one cent every time the game device 10 is played. Alternatively, or in addition to other methods of increasing the progressive prize value, the progressive prize value may be increased automatically over time.

According to one embodiment of a scratch-ticket game, a player wins the progressive prize or a portion of the progressive prize depending on the number of progressive symbols 106 the player uncovers. For example, a progressive prize may be awarded when a player uncovers three progressive symbols. The progressive prize may be a monetary prize, or another progressive prize such as credits or playing time on the game device 10.

In one type of scratch-ticket game according to the present invention, the player is informed that a more valuable hidden symbol has been placed underneath a scratchable area 96 once the player has uncovered one or more valuable symbols. One or more junk symbols 104 may be placed in conjunction with the more valuable hidden symbol, to increase the risk to the player of going forward by uncovering another scratchable area 96. For example, a player may start a scratch-ticket game by uncovering two coin symbols 98 worth a total of $20. At this point, the game device 10 notifies the player that one or more valuable coin symbols 98, worth $200 for example, have placed so that activating some of the scratchable areas 96 will reveal the more valuable coin symbol 98. The player may also be notified that one or more junk symbols 104 have been placed. At this point, the player is given the choice between continuing to try to discover the $200 symbol or stopping play to retain the current winnings. Junk symbols 104 which end the game may be combined with junk symbols 104 which prolong the game.

The types of prizes awarded in a scratch-ticket game based on certain criteria may be stored in the game device 10 in the form of a scratch-ticket game prize table, which allows the game device 10 to determine the prize that should be awarded to the player in response to the achievement of certain goals by a player during the scratch-ticket game. For example, a table lookup may show that uncovering two coin symbols 98 results in an award of $30 for a player, while uncovering three coin symbols 98 results in an award of $90 for the player. Alternatively, where game devices 10 are connected to a network, as described below, a scratch-ticket game prize table may be stored on a server or a central database which is contacted by the game devices 10. This embodiment allows the centralized updating of a scratch-ticket game prize table rather than a need for manually updating individual game devices 10 with new scratch-ticket game prize tables as game operators wish to change prize values or the criteria for winning prizes.

The symbols described above in conjunction with a scratch-ticket game according to the present invention may also be used in other chance-based games provided by game devices 10 under the present invention. For example, similar symbols may be used as special cards in a card game, special dice rolls in a dice game, or special reel images in a slot game. Further, uncovered symbols may be animated to provide more excitement for the player. For example in one embodiment, a junk symbol 104 showing a bomb explodes when it is uncovered by a player, to show that the scratch-ticket game has ended.

FIG. 7 shows two game devices 10 connected to each other through a connection hub 108. Though FIG. 7 shows only two game devices 10 connected to each other, it is to be understood that dozens or more could be connected through a single connection hub 108 or through several connection hubs. Other connection schemes are possible, for example multiple game devices 10 may be connected directly to each other, or multiple game devices 10 may be connected directly to a server 110. All network connections may be cabled connections, or some or all network communication may be wireless communication.

A server 110 may be used to coordinate and administer games on a game network 112. Game devices 10 connected to the game network 112 allow several functions not available on stand-alone games. The network 112 may allow competitions or tournaments between players located at the same location or at locations in different geographic areas. In a multiplayer game, a player at one game device 10 may challenge a player at another game device for a number of credits or a certain amount of time, and then play a chance-based or skill-based game to determine the winner of the credits or time. Networked games such as those shown in FIG. 7 may play the same types of games as stand-alone games, or they may have a specialized selection of network-oriented games.

The server 110 may be adapted to communicate with a central database 114. In an embodiment where a player's credits and other information are stored within the network 112, the central database 114 stores information such as each player's current available credits and/or time and the player's historical use of credits and/or time. Further, the central database 114 may store cumulative information on players' performance over time. To enable communication with the connection hub 108, other game devices 10, or the server 110, the game devices 10 are provided with communication modules 116. The communication modules 116 may be modems, network cards, or wireless communication devices.

The use of a network 112 enables more valuable prizes to be awarded to players of the game devices 10. For example, game operators may wish to set up a contest allowing a player to win a single grand prize, such as a new sports car. The use of a network 112 allows constant monitoring of game devices 10 by the server 110. The server 110, which administers the games, may be notified by the game device 10 when a player wins the grand prize. The server 110 may then instantly notify all game devices 10 with which it communicates that the grand prize has been won, informing the game devices 10 that no other grand prizes can be awarded. In this manner, traditional sweepstakes may be carried out very quickly, with players having a chance to win a very valuable prize with every play of the game device while the grand prize is still available. If the present invention is to be used in this sweepstakes embodiment, an alternative form of playing a chance-based game for free without requiring a player to play an initial skill-based game may be provided to prospective players.

The use of the network 112 also allows a progressive game to be carried out among many game devices 10. When several game devices 10 are connected via a network 112, an overall progressive prize for the entire network 112 may be built up by tallying inputs from all of the connected game devices 10. The total amount of a networked progressive prize may be stored at the server 110 or the central database 114, or it may be stored locally at game devices 10. The winner of a progressive prize under the networked embodiment allows a large progressive prize to be won by only one participant, because every game device 10 connected via the network 112 can be informed that the progressive prize has been awarded. This prevents any game device 10 connected to the network 112 from awarding a progressive prize once another connected game device 10 has awarded a progressive prize.

Other prize structures may be employed when the network 112 is used. For example, a tournament may be provided with a pre-set number of prizes to be awarded. When a pre-set number of prizes is to be awarded, the server 110 or a centralized prize computer repeatedly updates a ranked list of players based on information received from the connected game devices 10. At the end of the tournament, which may be decided based on time or based on the number of total plays of the game devices 10, the server 110 or centralized prize computer associates the top-ranked players with the prizes, in descending order of prize value. Thus, the players having the best tournament outcomes are rewarded the most valuable prizes, up to the number of prizes available. For example, if ten total cash prizes, valued from $10 to $100 are to be awarded, the server 110 or centralized prize computer ranks the top ten players in a tournament and associates the prize values with the top ten players' information so that the top player gets $100, the tenth-ranked player gets $10, and the intermediate players get their proper prize value sent to them. Tie-breakers, such as tie-breaking trivia questions in a trivia tournament, tie-breaking levels in an arcade game tournament, or tie-breaking scratch cards in a chance-based game tournament may be employed. Player rankings may be based on individual performances in single gaming sessions, or they may be based on scores averaged or summed over several gaming sessions.

Chance-based games according to the present invention, including chance-based games with cash prizes, may be presented either as tournament games or following tournament games, including tournament games as described in the provisional U.S. patent application, “Tournament Network for Linking Amusement Games,” serial No. 60/271,968, filed on Feb. 28, 2001 and incorporated herein by reference in its entirety.

While the present invention has been described with reference to one or more particular embodiments, those skilled in the art will recognize that many changes may be made thereto without departing from the spirit and scope of the present invention. Each of these alternative embodiments and obvious variations thereof is contemplated as falling within the spirit and scope of the claimed invention, which is set forth in the following claims.

What is claimed is:

1. A method of operating an amusement game having both a chance-based game and a skill-based game, the method comprising:
operating a skill-based video game as a primary game, the skill-based video game having a skill-based video game outcome; and
operating a chance-based video game as a secondary game, the chance-based video game having a chance-based video game outcome.

2. The method of claim 1 wherein the chance-based game is chosen from the group consisting of slots, bingo, keno, roulette, and dice.

3. The method of claim 1 wherein the skill-based game is chosen from the group consisting of racing games, fighting games, trivia games, sports games, logic games, and puzzle games.

4. The method of claim 1 wherein operating a chance-based video game as a secondary game occurs regardless of the skill-based video game outcome.

5. The method of claim 1 further comprising awarding a player with a cash prize based on the outcome of one or both of the skill-based video game outcome and the chance-based video game outcome.

6. A game device for playing chance-based and skill-based games, comprising:
a central game processor adapted to coordinate game presentation;
a display providing video representations of games in response to signals from the central game processor;
a memory accessible by the central game processor and containing data related to chance-based and skill-based games; and
a storage device adapted to record information related to a player and write information related to the player for future use by the game device.

7. The game device of claim 6 wherein the storage device is adapted to read identification information from player cards.

8. The game device of claim 6 wherein the central game processor is adapted to reward credits based on player success in chance-based games and deduct credits based on player failure in chance-based games.

9. A method of presenting chance-based and skill-based games to a player comprising:
accepting credits from a player to form an initial credit value for a game session;
providing the player with a choice between a chance-based game and a skill-based game;
performing the game chosen by the player; and
altering the initial credit value to an updated credit value for the game session in response to the player's performance.

10. The method of claim 9, further comprising providing the player with a choice between choosing another game or termination of the game session.

11. The method of claim 9, further comprising providing the player with a player credit indicator, the player credit indicator being the updated credit value for the game session at the time of termination of the game session.

12. The method of claim 111 wherein providing the player with a player credit indicator includes updating a player card with player credit information.

13. The method of claim 111 wherein providing the player with a player credit indictor includes providing the player with a visual display of the number of remaining credits and storing the number of remaining credits at a central database.

14. A method of presenting chance-based and skill-based games to multiple players, the method comprising:
coordinating gameplay by a first player playing a first game device, said first game device including a chance-based game and a skill-based game, and being in communication with a connection hub;
coordinating gameplay by a second player playing a second game device, said second game device including a chance-based game and a skill-based game, and being in communication with the connection hub;
accepting gameplay signals generated by the first game device and the second game device at the connection hub;
forwarding gameplay signals from the first game device through the connection hub to the second game device; and
forwarding gameplay signals from the second game device through the connection hub to the first game device.

15. The method of claim 14 further comprising forwarding game status signals from the connection hub to a central database, said game status signals including player credit information.

16. The method of claim 14 further comprising allowing the first player and the second player to challenge each other, the outcome of the challenge determining an allocation of credits between the first player and the second player.

17. The method of claim 14 wherein the chance-based games are selected from the group consisting of bingo, keno, slots, roulette, wheel of fortune, dice games, and a video scratch game.

18. The method of claim 14 wherein the skill-based games are selected from the group consisting of racing, fighting, puzzle, adventure, role playing, sports, and strategy games.

19. A method of presenting a game and rewarding a prize to a player comprising:
presenting an initial skill-based game;
determining a skill-based game outcome of the initial skill-based game;
presenting a chance-based game in response to the outcome of the initial skill-based game meeting predetermined criteria;
determining a chance-based game outcome of the chance-based game; and
awarding a prize in response to the outcome of the chance-based game meeting at least one predetermined criterion.

20. The method of claim 19 wherein the chance-based game is selected from the group consisting of slots, dice, roulette, bingo, and a scratch-ticket game.

21. The method of claim 19 wherein the skill-based game is selected from the group consisting of fighting games, sports games, shooting games, trivia games, and puzzle games.

22. A game device adapted to provide skill-based and chance-based games comprising:
a display;
one or more input devices adapted to alter gameplay as shown on the display;
a central game processor; and
one or more memory devices, wherein the central game processor and the memory devices are adapted to first operate an initial skill-based game on the display, the initial skill-based game having a skill-based game outcome, the game processor and memory devices further being adapted to operate a chance-based game on the display if the skill-based game outcome meets at least one predetermined criterion.

23. The game device of claim 22 wherein the at least one predetermined criterion includes the achievement of at least a predetermined score in the initial skill-based game.

24. A method of operating at least one skill-based game and at least one scratch-ticket game for a player, comprising:
operating an initial skill-based game having an initial skill-based game outcome;
evaluating the initial skill-based game outcome;
operating a scratch-ticket game in response to the initial skill-based game outcome meeting a predetermined skill-based game criterion, the scratch-ticket game allowing a player to select scratchable areas on a video representation of a scratch-ticket and revealing scratch-ticket symbols in response to the selection of the scratchable areas, the scratch-ticket game having at least one scratch-ticket game outcome;
evaluating the at least one scratch-ticket game outcome; and
awarding at least one prize if the at least one scratch-ticket game outcome meets at least one predetermined scratch-ticket game criterion.

25. The method of claim 24 wherein awarding at least one prize comprises comparing the at least one scratch-ticket game outcome to a scratch-ticket game prize table and awarding a prize based on the contents of the scratch-ticket game prize table.

26. The method of claim 25 wherein said scratch-ticket symbols include prize symbols which indicate the progression of the player toward a prize and junk symbols which indicate that a player has not advanced toward a prize.

27. The method of claim 25 wherein revealing a junk symbol results in the termination of the scratch-ticket game.

28. The method of claim 26 wherein said scratch-ticket symbols further include progressive symbols which indicate an advancement toward a progressive prize.

29. A method of operating an amusement game comprising:
providing an initial skill-based game having an initial skill-based game outcome;
evaluating the initial skill-based game outcome;
providing a scratch-ticket game if the initial skill-based game outcome meets at least certain predetermined skill-based game criteria, the scratch-ticket game allowing a player to select scratchable areas on a video representation of a game ticket and revealing scratch-ticket symbols in response to the selection of the scratchable areas, the scratch-ticket game having at least one scratch-ticket game outcome, the scratch ticket symbols including progressive symbols;
evaluating the at least one scratch-ticket game outcome; and
awarding a progressive prize whose value is based at least in part on the number of previous plays of the scratch-ticket game if the at least one scratch-ticket game outcome matches predetermined progressive prize criteria.

30. The method of claim 29 wherein the predetermined progressive prize criteria include uncovering at least two progressive prize symbols.

31. The method of claim 29 wherein the value of the progressive prize is based solely on the number of times the scratch-ticket game has been played previously, and further wherein the award of a progressive prize resets the progressive prize to zero.

32. The method of claim 29 wherein the value of the progressive prize is based in part on the number of times the scratch-ticket game has been played previously and in part on the amount of time since a previous win of the progressive prize.

33. A game device comprising:
a central game processor adapted to coordinate game presentation;
a display providing a video representation of games in response to signals from the central game processor;
a memory accessible by the central game processor and containing data related to chance-based and skill-based games, the data including scratch-ticket data related to a chance-based scratch-ticket game, said central processor causing said display to generate a game ticket having a plurality of scratchable areas on the display in response to said central processor accessing said scratch ticket data;
an input device adapted to receive input from a user relating to the choice of one or more of the scratchable areas on the display, the central game processor generating a symbol on said display in response to the player selecting one of the scratchable areas.

34. The game device of claim 33 wherein the scratch-ticket game has a scratch-ticket game outcome and the central game processor is adapted to compare the scratch-ticket game outcome with predetermined scratch-ticket game criteria.

35. The game device of claim 33 wherein the input device is a touch screen interface.

36. The game device of claim 33 wherein said central game processor further alters symbols for display in response to the player selecting one or more of the scratchable areas.

37. A method of providing at least one skill-based game and at least one chance-based game to a plurality of players, comprising:
providing an initial skill-based game to a plurality of players, the initial skill-base game having an initial skill-based game outcome;
reporting each initial skill-based game outcome to a central location;
comparing the initial skill-based game outcomes to predetermined skill-based game criteria;
providing a chance-based game to those players whose initial skill-based game outcomes meet said predetermined skill-based game criteria, the chance-based game having a chance-based game outcome;
reporting each chance-based game outcome to the central location;
receiving information regarding all chance-based game outcomes from the central location;
comparing the chance-based game outcome to predetermined chance-based game criteria; and
awarding a grand prize to a grand prize winner in response to the chance-based game outcome associated with the grand-prize winner meeting certain of said predetermined chance-based game criteria.

38. A game device for providing at least one skill-based game and at least one chance-based game, comprising:
a central game processor adapted to:
a) provide an initial skill-based game having an initial skill-based game outcome,
b) compare the initial skill-based game outcome to predetermined criteria for skill-based game outcomes,
c) provide a chance-based game having a chance-based game outcome if the comparison of the initial skill-based game outcome to the predetermined criteria for skill-based game outcomes indicates that criteria for providing a chance-based game have been met,
d) compare the chance-based game outcome to predetermined chance-based game criteria; and
e) award a prize if the comparison of the chance-based game outcome and the predetermined chance-based game criteria indicate that the criteria for awarding a prize have been met;
a display adapted to display the at least one skill-based game and the at least one chance-based game;
a memory containing data related to the chance-based and skill-based games; and
a communication module adapted to send and receive data to and from other devices.
